(19) United States
(12) Patent Application Publication
(10) Pub. No.: US 2018/0292621 A1
(43) Pub. Date: Oct. 11, 2018

(54) OPTICAL COMPONENT

(71) Applicant: SUMITOMO ELECTRIC INDUSTRIES, LTD., Osaka (JP)

(72) Inventors: Takuya NANJO, Osaka (JP); Tetsuya NAKANISHI, Osaka (JP)

(73) Assignee: SUMITOMO ELECTRIC INDUSTRIES, LTD., Osaka (JP)

(21) Appl. No.: 15/946,989

(22) Filed: Apr. 6, 2018

(30) Foreign Application Priority Data
Apr. 10, 2017 (JP) 2017-077836

(51) Int. Cl. G02B 6/42; G02B 6/44; G01S 7/481

(52) U.S. Cl. CPC G02B 6/4257; G01S 7/4818; G02B 6/4439

(57) ABSTRACT

There is provided an optical component that, after an optical fiber having a bent portion is housed in the optical component, allows the end face of the optical fiber to be easily polished. The optical component includes an optical fiber, a retainer, and a supporter. The optical fiber includes a linear portion including an end face, a bent portion contiguous to the linear portion, and an extension portion on the opposite side from the linear portion with a bent portion interposed between the linear portion and the extension portion. The retainer retains the linear portion of the optical fiber. The supporter supports the extension portion from the end face. The retainer projects from the bent portion toward the end face.

### BACKGROUND OF THE INVENTION

### Field of the Invention

The present invention relates to an optical component that connects an optical fiber to an optical module or an electronic component.

### Description of the Related Art

Along with development of high density mounting of electronic components used for optical communication, there is growing demand for low-profile optical components used with an optical module or an electronic component. For this reason, an optical component including an optical fiber having a bent portion has been proposed. As an example, Japanese Unexamined Patent Application Publication No. 2011-7946 describes an optical component in which an optical fiber having a bent portion is housed in a hollow portion extending in a longitudinal direction of the optical fiber, a linear portion closer to a leading end than the bent portion is disposed in an inner sidewall of an optical component body, and an elongated cover member holds the inner sidewall and the linear portion of the optical fiber, and closes the hollow portion. Also, formation of a bent portion of an optical fiber is described, for instance, in Japanese Unexamined Patent Application Publication No. 2015-218090.

### SUMMARY OF THE INVENTION

When an optical fiber is connected to an electronic component, the end face at the leading end is polished in some cases. In the above-described optical component, the end face and the lower surface of the cover member are located on the same plane, and thus the lower surface of the cover member needs to be polished along with the end face, and the area to be polished is increased and effort and time are necessary. Also, when the linear portion of the optical fiber is connected to an optical module or an electronic component with the linear portion tilted from the normal direction of the optical module or the electronic component, the cover member needs to be widely polished, and thus further effort and time are necessary.

It is an object of the present invention to provide an optical component that, after an optical fiber having a bent portion is housed in the optical component, allows the end face of the optical fiber to be easily polished.

The optical component of the present invention includes: an optical fiber including a linear portion including an end face, a bent portion contiguous to the linear portion, and an extension portion on an opposite side from the linear portion with the bent portion interposed between the linear portion and the extension portion; a retainer that retains the linear portion; and a supporter that supports the extension portion from the end face. The retainer projects from the bent portion toward the end face.

In the optical component of the present invention, space may be present between a reference plane including the end face and the supporter. The bent portion has a bend angle of at least 70 degrees and at most 90 degrees, as an example.

In the optical component of the present invention, the retainer may have a V-groove substrate having a groove which houses the linear portion, and a cover member that covers the groove and the linear portion. In this case, the cover member may have a thickness of at most twice the thickness of the V-groove substrate. Also, the distance by which the retainer projects from the supporter may be at most three times a thickness of the V-groove substrate.

In the optical component of the present invention, in the bent portion, a coating may be removed and a stress may be released.

In the optical component of the present invention, a portion on the opposite side of the supporter from the linear portion with the bent portion interposed between the portion and the linear portion may fix the optical fiber via a coating of the optical fiber. Also, the supporter may have a support surface that supports a resin material which covers the bent portion. In this case, the glass transition point of the resin material may be at least 85 degrees centigrade, and the hardness shore D of the resin material may be at least 50. In the optical component of the present invention, the supporter may be made of metal or may have undergone metallization processing.

According to the present invention, it is possible to provide an optical component that, after an optical fiber having a bend portion is housed in the optical component, allows the end face of the optical fiber to be easily polished.

### BRIEF DESCRIPTION OF THE DRAWINGS

FIG. 1A is a perspective view illustrating a state where an optical component according to an aspect of the present invention is connected to an electronic component.

FIG. 1B is a side view of the optical component of FIG. 1A.

FIG. 1C is an illustration showing a side view of an optical fiber included in the optical component of FIG. 1A.

FIG. 2 is an exploded perspective view of the optical component of FIG. 1A.

FIG. 3A is a perspective view illustrating a state where an optical component according to another aspect of the present invention is connected to an electronic component.

FIG. 3B is an exploded perspective view of the optical component according to another aspect of the present invention.

### DESCRIPTION OF THE PREFERRED EMBODIMENTS

Specific examples of an optical component according to the present invention will be described with reference to the drawings. It is to be noted that the present invention is not limited to these examples, and is shown by the accompanying claims, and it is intended that all modifications in the sense and range of the equivalents of the claims are included in the scope of the present invention.

### Embodiment 1

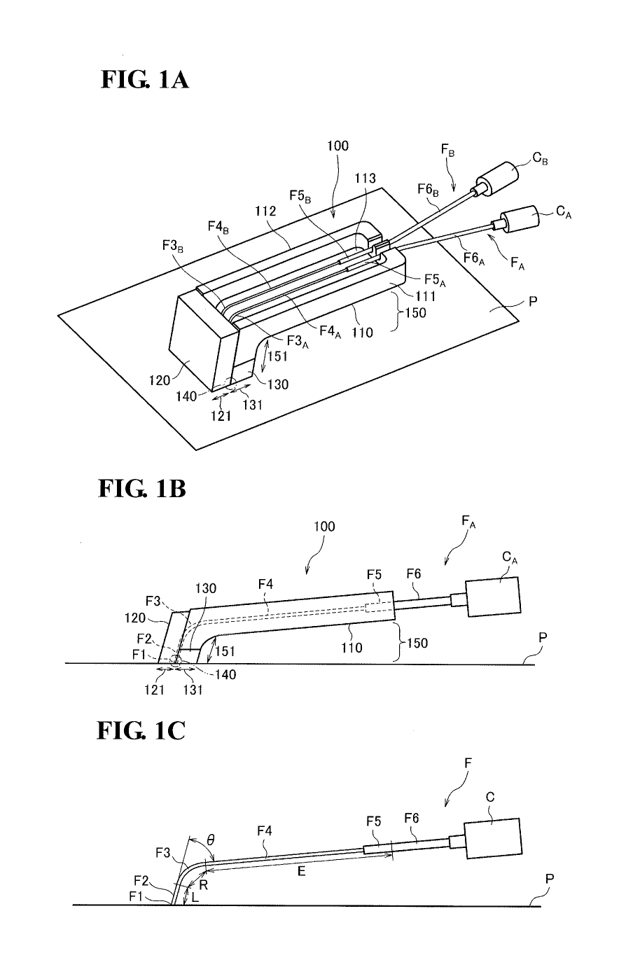

FIG. 1A is a perspective view illustrating a state where an optical component 100 according to Embodiment 1 of the present invention is connected to an electronic component. FIG. 1B is a side view of the optical component 100. FIG. 1C is an illustration of a side view of the shape of optical fibers F_{A} and F_{B} included in the optical component 100, as seen in the side direction of the optical component 100. The optical component 100 includes the optical fibers F_{A} and F_{B}. It is to be noted that the number of optical fibers included in the optical component 100 is not limited to two, and may be one, or may be three or greater.

The optical fibers F_{A} and F_{B} are referred to as the optical fiber F. Referring to FIG. 1C, the optical fiber F extends over a region L, a region R, a region E, and a connection area connected to another optical component C (for instance, a ferrule C for optical connector) contiguous to the region E. The region L, the region R, and the region E, which are part of the optical fiber F, are housed in the optical component 100.

In the region L, the optical fiber F has an end face F1 and a linear portion F2. The end face F1 is the face formed by the leading end of the linear portion F2 of the optical fiber F. The end face F1 is connected to an electronic component such as an optical module, and an optical signal is inputted and outputted to and from the optical fiber F via the end face F1. The linear portion F2 is a linear portion contiguous to the end face F1. It is to be noted that plane P is a plane to which the end face F1 is contacted, and is a reference plane that is a plane including the end face F1. For instance, the reference plane P is also a plane of a connection portion, to which the end face F1 is connected by the optical component 100, of an electronic component. It is to be noted that the end face F1 is polished to have a curved face shape to practice physical contact, and when a planar shape is not included, a tangent plane at a cross point where the end face F1 crosses the optical axis of the optical fiber F can be the reference plane P.

In the region R, the optical fiber F has a bent portion F3. The bend portion F3 is a portion of the optical fiber F contiguous to the linear portion F2. The bent portion F3 is bent with a predetermined bend radius. The bend angle is at most 90 degrees, for instance. As described below, a low-profile optical component 100 call be achieved by setting the bend angle to 90 degrees or less. Also, the lower limit of the bend angle can be set to 70 degrees, for instance.

It is to be noted that although the optical fiber F has a glass fiber and a coating that covers the glass fiber, it is preferable that the coating be removed, and the glass fiber be exposed in at least the bent portion F3. Since the coating is removed, as described in Japanese Unexamined Patent Application Publication No. 2015-218090, for instance, the bent portion F3 undergoes bend processing while being irradiated with a laser beam from the side of the glass fiber so that stress can be prevented from occurring, and thus change in the characteristics of the optical fiber F can be prevented. Also, the coating of the linear portion F2 may also be removed along with the removal of the coating of the bent portion F3. Removal of the coating of the linear portion F2 makes it easy to align and hold the linear portions F2 of multiple optical fibers, for instance, by using a V-groove substrate.

In the region E, the optical fiber F has a first extension portion F4 and a second extension portion F5. The first extension portion F4 is a portion contiguous to the bent portion F3. Also, the second extension portion F5 is a portion contiguous to the first extension portion F4. The first extension portion F4 and the second extension portion F5 are portion that extend on the opposite side from the linear portion F2 with the bent portion F3 interposed between the linear portion F2 and the first extension portion F4 and the second extension portion F5.

The first extension portion F4 and the second extension portion F5 have a substantially linear shape. Here, the reason why the first extension portion F4 and the second extension portion F5 are described as having a substantially linear shape is that it is intended that the first extension portion F4 and the second extension portion F5 do not need to have a linear shape approximately equivalent to that of the linear portion F2 in order to prevent stress from being applied to the bent portion F3. Since the first extension portion F4 is a portion contiguous to the bent portion F3, a coating may be removed. The second extension portion F5 may have a coating.

A portion F6 (connection region) of the optical fiber F contiguous to the region E is a portion that connects the optical fiber F to another optical component C, and is a portion that extends to the outside of a support member 110. For instance, as illustrated in FIG. 1A, the second extension portion F5 can be mounted and fixed to a recessed portion of at an end of the support member 110 via a coating. Therefore, even when a force is applied to the connection region, force can be prevented from being applied to the bent portion F3 in conjunction with the retention of the linear portion by a retainer including a retention substrate 120 and a substrate cover member 130.

Next, the configuration of the optical component 100 will be described with reference to FIG. 1A and FIG. 1B. The optical component 100 have the optical fiber F, the support member 110, the retention substrate 120, and the substrate cover member 130.

The retention substrate 120 and the substrate cover member 130 sandwich the lateral sides of the linear portions F2 of the optical fibers F_{A} and F_{B}. Also, the sides, near the end face F1, of the retention substrate 120 and the substrate cover member 130 are in contact with the reference plane P. Since the sides, near the end face F1, of the retention substrate 120 and the substrate cover member 130 are in contact with the reference plane P in this manner, the optical fibers F_{A} and F_{B} can be more reliably connected to an optical module or an electronic component. It is to be noted that the portion, including the end face F1 and surrounded by a dashed dotted line, of the retainer may be referred to as an end face retainer 140. The optical fibers F_{A} and F_{B} are connected to an optical module or an electronic component via the end face retainer 140.

The support member 110 forms a supporter, and supports the first extension portion F4 and the second extension portion F5 of the optical fibers F_{A} and F_{B} from the side, near the end face F1, of the optical fibers F_{A} and F_{B}. The first extension portion F4 and the second extension portion F5 of the optical fibers F_{A} and F_{B} are placed on a bottom surface 113 of the support member 110 in the direction from the bent portion F3 to the end face F1. It is to be noted that the first extension portion F4 and the second extension portion F5 of the optical fibers F_{A} and F_{B} do not need to be in contact with the bottom surface 113.

Also, the support member 110 has sidewalls 111 and 112 on both sides of the bottom surface 113. The sidewalls 111 and 112 are connected at an end of the optical component 100, and a recessed portion for retaining the optical fibers F_{A} and F_{B} is formed at the end. The optical fibers F_{A} and F_{B} are retained in the recessed portion, and thus fixed to the support member 110. It is to be noted that although there are two recessed portions in FIG. 1A, similarly to the number of optical fibers included in the optical component 100, the number of recessed portions may be any number.

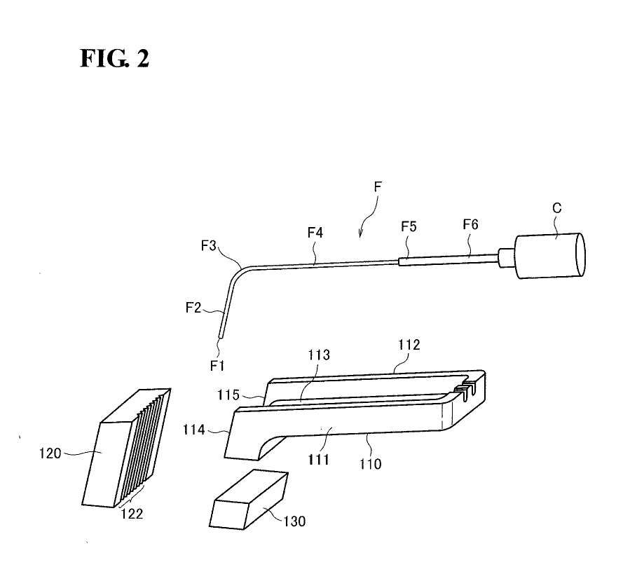

A sidewall leading end, which is located on the opposite side of the sidewalls 111 and 112 from the end in which the recessed portion is formed and which is located near the bent portion F3 of the optical fibers F_{A} and F_{B}, is in contact with the retention substrate 120 and the substrate cover member 130, and thus the support member 110, the retention substrate 120, and the substrate cover member 130 are fixed together. More specifically, the side, near the bent portion F3, of the sidewalls 111 and 112 has an extension portion and a projection portion. Similarly to the bottom surface 113, the extension portion extends substantially parallel to the first extension portion F4 and the second extension portion F5 of the optical fibers F_{A} and F_{B}. Also, the projection portion projects in the direction from the bent portion F3 to the linear portion F2 in conformity with the bending of the bent portion F3 of the optical fibers F_{A} and F_{B}. The leading end of the projection portion is in contact with the substrate cover member 130, and the lateral sides (lateral sides 114 and 115 in FIG. 2 referred to late) of the projection portion are in contact with the retention substrate 120.

Since the leading end of the projection portion is in contact with the substrate cover member 130, and the end face retainer 140 includes a portion that is in contact with the reference plane P of the substrate cover member 130, the end face retainer 140 projects in the extension direction of the linear portion F2 rather than the support member 110. Therefore, space 150 is present between the bottom surface 113 of the support member 110 and the reference plane P. Thus, when the retention substrate 120 and the substrate cover member 130 which include the end face retainer 140 are polished with tilted to the optical axis of the optical fibers F_{A} and F_{B} in order to adjust the angle of the end face F1 of the optical fibers F_{A} and F_{B} with respect to the optical axis of the fibers, the amount of polish can be smaller than in the related art, and polishing is facilitated.

Also, as respective thicknesses 121 and 131 of the retention substrate 120 and the substrate cover member 130 are reduced, the amount of polish of the retainer can be reduced. Thus, it is preferable that the thickness 131 of the substrate cover member 130 be at most twice the thickness 121 of the retention substrate 120. In particular, when the bend angle θ of the bent portion of the optical fibers F_{A} and F_{B} is at least 70 degrees and at most 90 degrees, in order to decrease the distance from the reference plane P at the end on the opposite side of the support member 110 from the retention substrate 120, it is sufficient that the side, near the reference plane P, of the substrate cover member 130 be polished. Therefore, setting the thickness 131 of the substrate cover member 130 at most twice the thickness 121 of the retention substrate 120, and an upper limit of the thickness 131 has a technical significance. It is to be noted that the lower limit of the thickness 131 of the substrate cover member 130 can be one times the thickness 121 of the retention substrate 120. One of the reasons why the lower limit of the thickness 131 of the substrate cover member 130 is set to one times the thickness 121 of the retention substrate 120 is to facilitate the handling of the substrate cover member 130 at the time of assembling of the optical component 100.

In order to cope with a demand for an optical component 100 to have a low-profile, the distance of the end of the support member 110 from the reference plane P is to be reduced, and a distance 151 by which the retainer projects from the support member 110 is to be reduced. In other words, the distance 151 by which the end face retainer 140 projects from the support member 110 is to be reduced. Then, it is preferable that the distance 151 be at most three times the thickness 121 of the retention substrate 120. Also, when the distance 151 is decreased, the distance to an optical module or an electronic component is decreased, and the optical component 100 is likely to be affected by the heat emitted by an optical module or an electronic component. Thus, it is preferable that the distance 151 be one times the thickness 121 of the retention substrate 120 to prevent the optical component 100 from being affected by the heat emitted by an optical module or an electronic component.

FIG. 2 is an exploded perspective view of the optical component 100, and illustrates an example in which a glass substrate, in which multiple V-grooves 122 are formed, is used as the retention substrate 120. The linear portion F2 of one optical fiber F is inserted in one of the V-grooves 122, and if necessary, the linear portion F2 of another optical fiber is inserted in another one of the V-grooves 122. At this point, the relative position of the retention substrate 120 and the optical fiber F is adjusted so that the bent portion F3 is not exposed above the sidewalls 111 and 112 of the support member 110 disposed later. The V-grooves 122 and the linear portion F2 of the optical fiber are then covered by the substrate cover member 130 which is a cover member. Similarly to the retention substrate 120, a member composed of glass may be used for the substrate cover member 130. In order to fix the retention substrate 120 and the substrate cover member 130, for instance, an adhesive is applied between the retention substrate 120 and the substrate cover members 130. The linear portion F2 of the optical fiber F can be retained more reliably using the retention substrate 120 in which the V-grooves are formed, and the substrate cover member 130, and the linear portions F2 of multiple optical fibers are easily arranged and housed.

Subsequently, the lateral sides 114 and 115 of the support member 110, the retention substrate 120, and the substrate cover member 130 are fixed by an adhesive or the like so that the bottom of the optical fiber F is supported by the support member 110 from the end face F1. Also, the boundary between the second extension portion F5 and an external connection portion F6 of the optical fiber F is fixed to the recessed portion at the end of the support member 110. Since the support member 110 has a shape more complicated than other members, a material which is easily shaped is used for the support member 110. For instance, metal or resin is used. When metal is used as the material of the support member 110, addition of water to the optical fiber du to moisture permeability from the support member 110 can be prevented. On the other hand, when a resin is used as the material of the support member 110, in order to prevent addition of water to the optical fiber due to moisture permeability from the support member 110, it is preferable that metallization processing has been performed on the surface of the support member 110.

In order to protect the first extension portion F4 of the optical fiber F, and if necessary, the bent portion F3 and the second extension portion F5, a resin material is filled on the bottom surface 113 to cover the first extension portion F4 of the optical fiber F, then the resin is hardened. For instance, when an ultraviolet curable resin is used as the resin material, the ultraviolet curable resin is irradiated with ultraviolet rays, and is cured. In this case, the bottom surface 113 may be referred to as the support surface of the resin material. Since the supporter has a support surface, the bent portion is covered with the resin material to protect the bent portion, and thus stress can be prevented from being applied to the bent portion.

Also, since the optical component 100 is disposed in the vicinity of an optical module and an electronic component, it is preferable that the glass transition point of the resin material be high so that the optical component 100 is not affected the heat emitted from an optical module or an electronic component. For instance, the glass transition point of the resin material can be set to 85 degrees centigrade. The heat resistance of the resin material is improved by setting the glass transition point of the resin material to at least 85 degrees centigrade, and the optical component can be used under the environment where an optical module and an electronic component are present. Also, in order to protect the optical fiber F (particularly, the bent portion F3) against the impact by an external force, it is preferable that the hardness shore D of the resin material be high, and for instance, the hardness shore D of the resin material can be set to at least 50.

### Embodiment 2

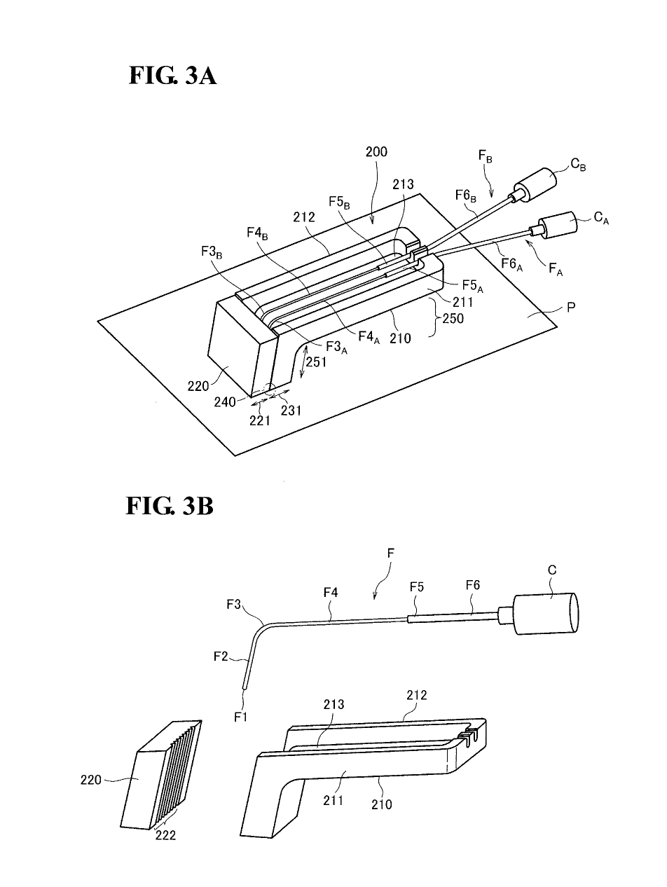

FIG. 3A is a perspective view illustrating a state where an optical component 200 according to Embodiment 2 is connected to an electronic component. Embodiment 2 is an embodiment of an optical component in which the support member 110 and the substrate cover member 130 are integrated to reduce the number of components in Embodiment 1. Since Embodiment 2 and Embodiment 1 are common and the same in many elements, the same component as in Embodiment 1 is labeled with a symbol from 200 to 251 having common lowest two digits, and a detailed description may be omitted.

As illustrated in FIG. 3A, the optical component 200 have a support member 210 and a retention substrate 220. The support member 210 has sidewalls 211 and 212 on both sides of a bottom surface 213. The sidewalls 211 and 212 has an extension portion that extends substantially parallel to the first extension portion F4 and the second extension portion F5 of the optical fibers F_{A} and F_{B}, and a projection portion that projects in the direction from the bent portion F3 to the linear portion F2 in conformity with the bending of the bent portion F3 of the optical fibers F_{A} and F_{B}. The leading end of the projection portion is located in the reference plane P, and the lateral sides of the projection portion are in contact with the retention substrate 220 and fixed.

The leading end portions, near the bent portion F3, of the optical fibers F_{A} and F_{B} are disposed in the retention substrate 220, and are pressed on the retention substrate 220 and fixed by the sidewalls 211 and 212. Therefore, the retention substrate 220 and the projection portion of the support member 210 form a retainer that retains the linear portion F2 of the optical fibers F_{A} and F_{B}. Also, the extension portion of the support member 210 forms a supporter.

FIG. 3B is an exploded perspective view of the optical component 200, and illustrates an example in which a glass substrate, in which multiple V-grooves 222 are formed, is used as the retention substrate 220. The linear portion F2 of one optical fiber F is inserted in one of the V-grooves 222, and if necessary, the linear portion F2 of another optical fiber is inserted in another one of the V-grooves 222. At this point, the relative position of the retention substrate 220 and the optical fiber F is adjusted so that the bent portion F3 is not exposed externally of the support member 210 disposed later.

Subsequently, the retention substrate 220 is brought into contact with the support member 210 so that the bottom of the optical fiber F is supported by the support member 210, and the support member 210 and the retention substrate 220 are fixed by an adhesive or the like. Also, the boundary between the second extension portion F5 and an external connection portion F6 of the optical fiber F is fixed to the support member 210. In order to protect the first extension portion F4 of the optical fiber F, and if necessary, the bent portion F3 and the second extension portion F5, a resin material is filled on the bottom surface 213 to cover the first extension portion F4 of the optical fiber F, then the resin is hardened.

A material which is easily shaped is used for the support member 210, for instance, metal or resin is used. When metal is used as the material of the support member 210, addition of water to the optical fiber can be prevented by moisture permeability from the support member 210. On the other hand, when a resin is used as the material of the support member 210, in order to prevent addition of water to the optical fiber by moisture permeability from the support member 210, it is preferable that metallization processing has been performed on the surface of the support member 210.

What is claimed is:

1. An optical component comprising:
an optical fiber including a linear portion including an end face, a bent portion contiguous to the linear portion, and an extension portion on an opposite side from the linear portion with the bent portion interposed between the linear portion and the extension portion;
a retainer that retains the linear portion; and
a supporter that supports the extension portion from the end face,
wherein the retainer projects from the bent portion toward the end face.

2. The optical component according to claim 1,
wherein space is present between a reference plane including the end face and the supporter.

3. The optical component according to claim 1,
wherein the bent portion has a bend angle of at least 70 degrees and at most 90 degrees.

4. The optical component according to claim 1,
wherein the retainer has a V-groove substrate having a groove which houses the linear portion, and a cover member that covers the groove and the linear portion.

5. The optical component according to claim 4,
wherein the cover member has a thickness of at most twice a thickness of the V-groove substrate.

6. The optical component according to claim 4,
wherein a distance by which the retainer projects from the supporter is at most three times a thickness of the V-groove substrate.

7. The optical component according to claim 1,
wherein in the bent portion, a coating is removed and a stress is released.

8. The optical component according to claim 7,
wherein a portion on an opposite side of the supporter from the linear portion with the bent portion interposed between the portion and the linear portion fixes the optical fiber via a coating thereof.

9. The optical component according to claim 3,
wherein in the bent portion, a coating is removed and a stress is released.

10. The optical component according to claim 9,
wherein a portion on an opposite side of the supporter from the linear portion with the bent portion interposed between the portion and the linear portion fixes the optical fiber via a coating thereof.

11. The optical component according to claim 1,
wherein the supporter has a support surface that supports a resin material which covers the bent portion.

12. The optical component according to claim 11,
wherein the resin material has a glass transition point of at least 85 degrees centigrade.

13. The optical component according to claim 11,
wherein the resin material has a hardness shore D of at least 50.

14. The optical component according to claim 1,
wherein the supporter is made of metal or has undergone metallization processing.
